(19) United States
(12) Patent Application Publication
(10) Pub. No.: US 2019/0251609 A1
(43) Pub. Date: Aug. 15, 2019

(54) COMMODITY DEMAND PREDICTION SYSTEM, COMMODITY DEMAND PREDICTION METHOD, AND COMMODITY DEMAND PREDICTION PROGRAM

(71) Applicant: NEC Corporation, Minato-ku, Tokyo (JP)

(72) Inventors: Takayuki NAKANO, Tokyo (JP); Yuuki KUBOTA, Tokyo (JP)

(73) Assignee: NEC Corporation, Minato-ku, Tokyo (JP)

(21) Appl. No.: 16/344,509

(22) PCT Filed: Oct. 18, 2017
(86) PCT No.: PCT/JP2017/037667

§ 371 Date: Apr. 24, 2019

(30) Foreign Application Priority Data
Oct. 31, 2016 (JP) 2016-212923

(51) Int. Cl. G06Q 30/06; G06N 20/00

(52) U.S. Cl. CPC G06Q 30/0605; G06N 20/00

(57) ABSTRACT

A learning unit 81 learns a prediction model, based on learning data including information about a raw material of a commodity and a demand quantity of the commodity. A prediction unit 82 predicts a demand quantity of a target commodity. Specifically, the prediction unit 82 predicts the demand quantity of the target commodity in a prediction target period, based on the prediction model and a raw material of the target commodity.

### TECHNICAL FIELD

The present invention relates to a commodity demand prediction system, a commodity demand prediction method, and a commodity demand prediction program for predicting commodity demand.

### BACKGROUND ART

A method of learning a prediction model based on past commodity transaction results and predicting future demand based on the prediction model has been widely known. For example, a prediction model is generated based on learning data including data such as past sales results, a store's business hours, campaign information, and weather information and a commodity demand quantity, and an explanatory variable value of a date subjected to prediction is substituted into the generated prediction model to obtain a prediction value.

In the case of a commodity with no past transaction results such as a new commodity or a commodity that could not be sold for a certain period of time due to stockout or the like, learning data for the commodity is insufficient, and therefore it is difficult to generate an appropriate prediction model by the above-described method. In view of this, a method of predicting demand in the case where there is no information about demand results before sales has been proposed.

For example, Patent Literature (PTL) 1 describes a system of performing demand prediction for a new commodity that has no past demand data. The system described in PTL 1 selects a commodity similar to the new commodity, calculates the base demand quantity of the new commodity from the past demand quantity of the similar commodity, and calculates the demand quantity of the new commodity from its sales start date onward.

### CITATION LIST

### Patent Literature

PTL 1: Japanese Patent Application Laid-Open No. 2015-32034

### SUMMARY OF INVENTION

### Technical Problem

With the system described in PTL 1, however, the determination of whether or not commodities are similar relies on human subjectivity, and the criteria are not obvious. In detail, with the system described in PTL 1, input of a commodity similar to a given commodity is received from a user and the input commodity is taken to be a similar commodity, but the method of similarity determination is unclear. Thus, the determination of whether or not commodities are similar relies on, for example, the subjectivity of a skilled person in charge of marketing, e.g. his or her past experience or guess. This may cause lower demand prediction accuracy.

In the case where there is no result data of the same commodity, the prediction model may be able to be learned by compiling the result data of a past commodity group similar to the new commodity. However, which commodity is to be compiled in the similar commodity group is not obvious, either. The accuracy of the prediction model thus relies on the subjectivity of a person with experience. This may cause lower demand prediction accuracy.

The present invention therefore has an object of providing a commodity demand prediction system, a commodity demand prediction method, and a commodity demand prediction program that can improve commodity demand prediction accuracy.

### Solution to Problem

A commodity demand prediction system according to the present invention includes: a learning unit which learns a prediction model, based on learning data including information about a raw material of a commodity and a demand quantity of the commodity; and a prediction unit which predicts a demand quantity of a target commodity, wherein the prediction unit predicts the demand quantity of the target commodity in a prediction target period, based on the prediction model and a raw material of the target commodity.

A commodity demand prediction method according to the present invention includes: learning a prediction model, based on learning data including information about a raw material of a commodity and a demand quantity of the commodity; and predicting a demand quantity of a target commodity in a prediction target period, based on the prediction model and a raw material of the target commodity.

A commodity demand prediction program according to the present invention causes a computer to execute: a learning process of learning a prediction model, based on learning data including information about a raw material of a commodity and a demand quantity of the commodity; and a prediction process of predicting a demand quantity of a target commodity, wherein in the prediction process, the computer is caused to predict the demand quantity of the target commodity in a prediction target period, based on the prediction model and a raw material of the target commodity.

### Advantageous Effects of Invention

According to the present invention, commodity demand prediction accuracy can be improved.

### BRIEF DESCRIPTION OF DRAWINGS

FIG. 1 is a block diagram depicting an example of the structure of an exemplary embodiment of a commodity demand prediction system according to the present invention.

FIG. 2 is an explanatory diagram depicting an example of learning data.

FIG. 3 is a flowchart depicting an example of the operation of the commodity demand prediction system.

FIG. 4 is an explanatory diagram depicting an example of a prediction model.

FIG. 5 is a block diagram depicting an overview of a commodity demand prediction system according to the present invention.

### DESCRIPTION OF EMBODIMENT

For example, a new commodity does not have past sales results, and accordingly a prediction model cannot be generated from the sales results of the commodity. Likewise, a commodity that could not be sold for a certain period of time due to stockout or the like does not have sales results during the period. Accordingly, if a prediction model is generated only from sales results, demand prediction accuracy decreases.

The inventors focused on not the past sales results of the commodity itself but the raw material of the commodity, and conceived an idea of using the past sales results of commodities including the raw material. Specifically, in the present invention, the demand quantity (e.g. the number of transactions, the number of sales, the number of orders) of the commodity is predicted using, as an explanatory variable, information about the raw material of the commodity (more specifically, the raw material, the weight or proportion of the raw material, etc.). An exemplary embodiment of the present invention will be described below, with reference to drawings.

### Exemplary Embodiment 1

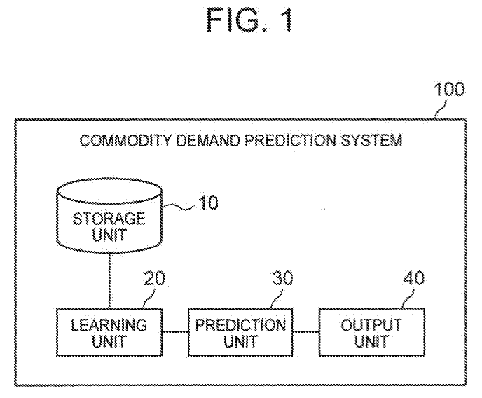

FIG. 1 is a block diagram depicting an example of the structure of Exemplary Embodiment 1 of a commodity demand prediction system according to the present invention. A commodity demand prediction system 100 in this exemplary embodiment includes a storage unit 10, a learning unit 20, a prediction unit 30, and an output unit 40.

The storage unit 10 stores learning data used for prediction model generation by the below-described learning unit 20. The storage unit 10 is implemented by, for example, a magnetic disk device. The below-described learning unit 20 and the storage unit 10 may be connected via a wired or wireless local area network (LAN), or connected via the Internet.

A prediction model is information representing the correlation between an explanatory variable and an objective variable. For example, the prediction model is a component for predicting a result of a prediction target by calculating the objective variable based on the explanatory variable. The prediction model is also referred to as “model”, “learning model”, “estimation model”, “prediction formula”, “estimation formula”, or the like.

The storage unit 10 stores learning data including information about the raw materials (or raw material) of each commodity (specifically, the raw materials, the weights of the raw materials, the proportions of the raw materials to the total weight of the commodity, etc.) and the demand quantity of the commodity. For example, in the case where the demand quantity is managed on a daily basis, the storage unit 10 stores learning data including the date of sale of the commodity, information about the raw materials of the commodity, and the demand quantity at the date of sale. Hereafter, the unit of the data collection period of the demand quantity included in the learning data is also referred to as “unit period”. For example, in the case where there is learning data on a daily basis, the unit period is a day.

As a specific example of this exemplary embodiment, suppose the quantity in which a commodity subjected to prediction (hereafter referred to as “target commodity”) is to be produced in a factory is to be predicted as a demand quantity. If the quantity in which the commodity is to be produced can be predicted, then raw materials necessary for the production of the target commodity in the factory can be predicted, too. As learning data, for example, sales data (e.g. point of sale (POS) data) of commodities acquired in stores in the past is used. For example, in the case where the target commodity is “bento” (box lunch), it is preferable to use, as learning data, sales data of commodities in the same category (i.e. bento) from among the past sales data.

In this exemplary embodiment, information about each raw material of each commodity is used as an explanatory variable. Hence, the storage unit 10 stores whether or not the raw material used as the explanatory variable is included in each commodity and, in the case where the raw material is included, the weight and weight proportion of the raw material. Examples of the target commodity include a new commodity, an existing commodity that has not been sold, and a commodity that does not have sales results for a certain period of time due to stockout or the like.

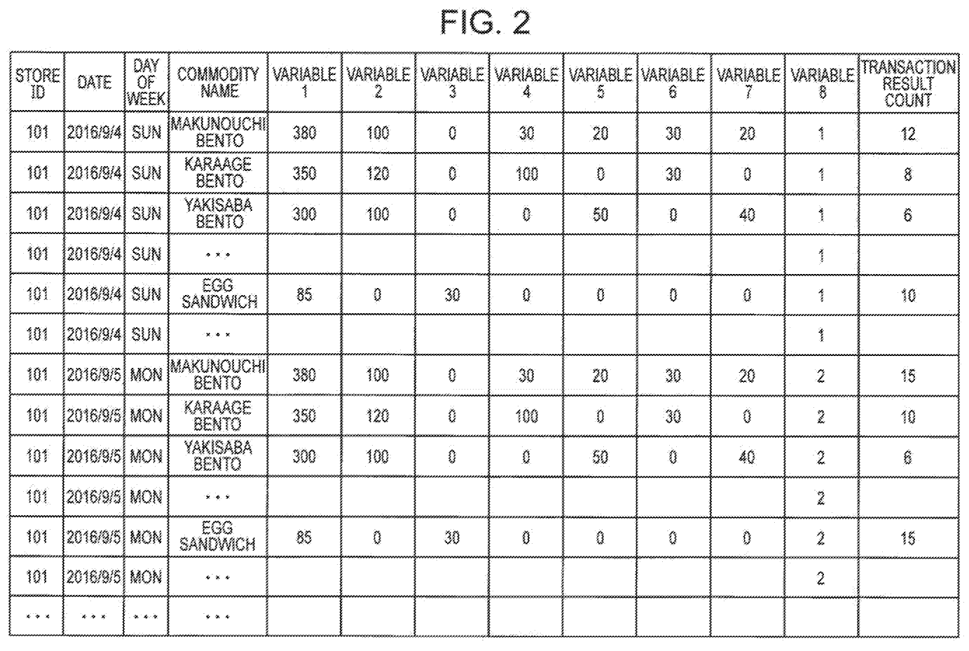

FIG. 2 is an explanatory diagram depicting an example of learning data stored in the storage unit 10. FIG. 2 depicts learning data including the total weight of each commodity sold, the raw materials included in the commodity, and the demand quantity of the commodity, for each store and each date (day of week). The transaction result count (demand quantity) depicted in FIG. 2 is, for example, the total of the sales quantities or the numbers of orders in each store.

In the example depicted in FIG. 2, a variable 1 represents the total weight of the commodity, and variables 2 to 7 represent the weights of predetermined raw materials included in the commodity (0 in the case where the raw material is not included, the weight in the case where the raw material is included). In the example depicted in FIG. 2, the variable 2 represents the weight of “rice”, the variable 3 represents the weight of “bread”, the variable 4 represents the weight of “fried chicken”, the variable 5 represents the weight of “grilled mackerel”, the variable 6 represents the weight of “spaghetti”, and the variable 7 represents the weight of “simmered dish”.

A variable 8 represents the day of week. In this exemplary embodiment, Sunday to Saturday are denoted respectively by 1 to 7.

Although FIG. 2 depicts an example in which the weight of each raw material is used as the learning data, the ratio of the weight of each raw material may be used as the learning data. In this case, for example, for “yakisaba bento” (grilled mackerel box lunch) in FIG. 2, the storage unit 10 may store the variables 1, 2, and 5 as 6:2:1. Thus, the storage unit 10 may store the ratio (proportion) of the weight of each raw material included in the commodity. Moreover, the storage unit 10 may store the sales of the commodity and information of the raw materials included in the commodity, as separate information (tables).

Although FIG. 2 depicts an example in which the learning data includes the total weight of each commodity, the raw materials included in the commodity, and the demand quantity of the commodity, the learning data may include other variables. Examples of the other variables include information indicating the property of each commodity, and information indicating the property of each day.

To classify each commodity, the learning data may include information indicating the category of the commodity. For example, in the case where the commodities are food products, the learning data may include information indicating categories such as “bento” and “onigiri” (rice ball). The learning data may also include information indicating categories hierarchically.

The learning unit 20 generates a prediction model based on the learning data described above. Specifically, the learning unit 20 generates one prediction model including a demand quantity as an objective variable and each variable (information) included in the learning data as an explanatory variable. The prediction model may be generated by any method. The learning unit 20 can generate the prediction model using a commonly known method. Since the prediction model generation method is widely known, its detailed description is omitted.

The prediction unit 30 predicts the demand quantity of the target commodity (i.e. commodity with insufficient learning data described above). Specifically, the prediction unit 30 predicts the demand quantity of the target commodity in a prediction target period, based on the prediction model generated by the learning unit 20 and the raw materials of the target commodity.

The demand quantity of the target commodity in the prediction target period is, for example, a demand quantity for a day or for a week, or a demand quantity according to ordering intervals.

A prediction method in the case of using the explanatory variables depicted in FIG. 2 will be described below, using a specific example. Suppose the demand quantity of a new commodity “healthy mix bento” is to be predicted.

The prediction model using the variables of the learning data depicted in FIG. 2 is, for example, expressed by the following Formula 1, where f is any function representing a prediction formula:

Demand quantity D=f(variable 1, variable 2, . . . , variable 7, variable 8) (Formula 1).

Consider the case of predicting the demand quantity on a Sunday. Suppose the raw materials of the new commodity include at least “rice”, “grilled mackerel”, and “simmered dish”. Also suppose, as the raw materials, “rice” is 80 g in weight, “grilled mackerel” is 40 g in weight, and “simmered dish” is 30 g in weight, and the total weight is 230 g. In such a case, variable 1=230, variable 2=80, variable 3=0, variable 4=0, variable 5=40, variable 6=0, and variable 7=30. Moreover, variable 8=1, as the demand quantity on Sunday is to be predicted.

The prediction unit 30 substitutes these variables into the foregoing Formula 1, to predict the demand quantity D on Sunday. In the case of calculating the total demand quantity in a certain period of time, for example, the demand quantities D predicated for the corresponding days of week may be added, and the addition result may be taken to be the total demand quantity.

The output unit 40 outputs the prediction result by the prediction unit 30. The output unit 40 is, for example, implemented by a display device.

The learning unit 20 and the prediction unit 30 are implemented by a CPU of a computer operating according to a program (commodity demand prediction program). For example, the program may be stored in the storage unit 10, with the CPU reading the program and, according to the program, operating as the learning unit 20 and the prediction unit 30. The functions of the commodity demand prediction system may be provided in the form of SaaS (Software as a Service).

The learning unit 20 and the prediction unit 30 may each be implemented by dedicated hardware. All or part of the components of each device may be implemented by general-purpose or dedicated circuitry, processors, or combinations thereof. They may be configured with a single chip, or configured with a plurality of chips connected via a bus. All or part of the components of each device may be implemented by a combination of the above-mentioned circuitry or the like and program.

In the case where all or part of the components of each device is implemented by a plurality of information processing devices, circuitry, or the like, the plurality of information processing devices, circuitry, or the like may be centralized or distributed. For example, the information processing devices, circuitry, or the like may be implemented in a form in which they are connected via a communication network, such as a client-and-server system or a cloud computing system.

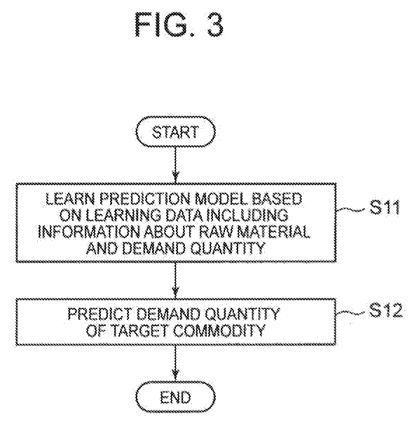

The operation of the commodity demand prediction system in this exemplary embodiment will be described below. FIG. 3 is a flowchart depicting an example of the operation of the commodity demand prediction system 100 in this exemplary embodiment.

The learning unit 20 learns a prediction model, based on learning data including information about a raw material of a commodity and a demand quantity of the commodity (step S11). The prediction unit 30 predicts a demand quantity of a target commodity in a prediction target period, based on the prediction model and a raw material of the target commodity (step S12).

As described above, in this exemplary embodiment, the learning unit 20 learns a prediction model, based on learning data including information about a raw material of a commodity and a demand quantity of the commodity. The prediction unit 30 then predicts a demand quantity of a target commodity. Specifically, the prediction unit 30 predicts the demand quantity of the target commodity in a prediction target period, based on the prediction model and a raw material of the target commodity. With such a structure, the demand prediction accuracy for a commodity with insufficient learning data can be improved.

That is, in the commodity demand prediction system in this exemplary embodiment, the prediction model is generated based on objective information, i.e. raw materials of commodities. Hence, the demand prediction accuracy can be improved even for a commodity with insufficient data (e.g. past data), such as a new commodity or a commodity that could not been sold for a certain period of time due to stockout or the like. In addition, since an operation of compiling commodities as a similar commodity group according to human subjectivity can be omitted, demand prediction not relying on subjectivity is possible.

Moreover, for example, for a factory that produces a new commodity, necessary quantities of raw materials can be determined prior to the sales of the new commodity. The risk of excess or shortage of raw materials can thus be avoided. For a store that sells the new commodity, the risk of dead stock or opportunity loss of the new commodity can be avoided.

A modification of Exemplary Embodiment 1 will be described below. In Exemplary Embodiment 1, the prediction model is represented by one prediction formula such as Formula 1. However, the prediction model is not limited to be represented by one prediction formula. The learning unit 20 may generate the prediction model with which a prediction formula is determined depending on the value of each variable used in the demand prediction of the target commodity. The prediction unit 30 may then specify, from the generated prediction model, the prediction formula depending on the value of each variable used in the demand prediction of the target commodity, and predict the demand quantity of the target commodity using the specified prediction formula.

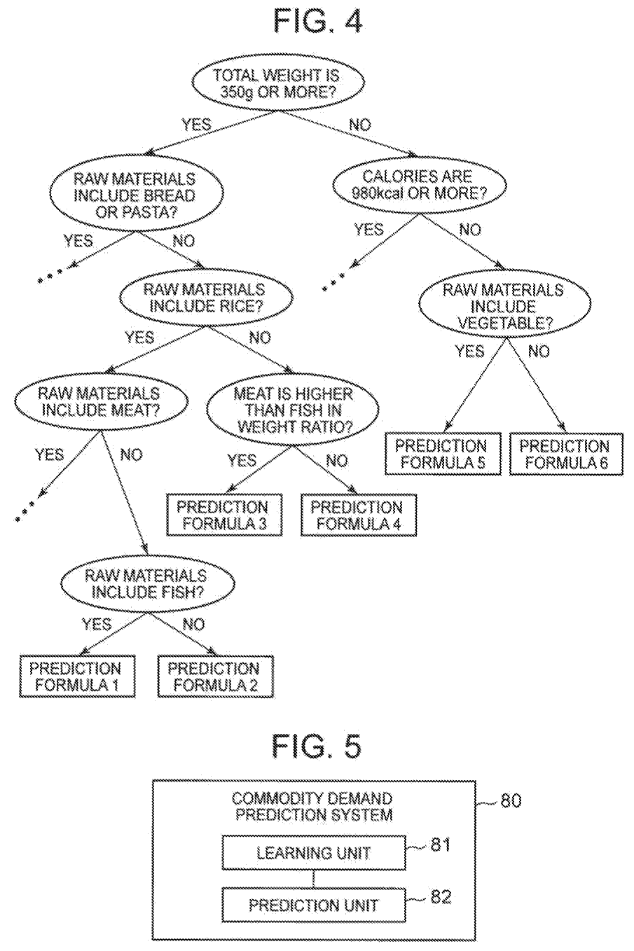

FIG. 4 is an explanatory diagram depicting an example of a prediction model with which a prediction formula is determined depending on the value of each variable specifying the target commodity. FIG. 4 depicts a prediction model in which a prediction formula selected is expressed by a tree structure. In the example depicted in FIG. 4, first, a candidate for the prediction formula is selected depending on whether or not the total weight is 350 g or more. Subsequently, for example, in the case where the total weight is less than 350 g, the calories are less than 980 kcal, and the raw materials include vegetable, a prediction formula 5 is selected.

An overview of the present invention will be given below. FIG. 5 is a block diagram depicting an overview of a commodity demand prediction system according to the present invention. A commodity demand prediction system 80 (e.g. commodity demand prediction system 100) according to the present invention includes: a learning unit 81 (e.g. learning unit 20) which learns a prediction model, based on learning data including information about a raw material of a commodity (e.g. the raw material, the weight, the proportion to the total weight) and a demand quantity of the commodity; and a prediction unit 82 (e.g. prediction unit 30) which predicts a demand quantity of a target commodity (e.g. the number of orders).

The prediction unit 82 predicts the demand quantity of the target commodity in a prediction target period, based on the prediction model and a raw material of the target commodity.

With such a structure, the demand prediction accuracy for a commodity with insufficient learning data can be improved.

The learning unit 81 may generate one prediction model including a demand quantity as an objective variable and a variable representing information about a raw material of a commodity as an explanatory variable.

Specifically, the learning unit 81 may learn the prediction model, based on the learning data including the raw material used in the commodity and the demand quantity of the commodity.

The learning unit 81 may learn the prediction model, based on the learning data including at least one of: a total weight of one or more raw materials of the commodity; a weight of each of the raw materials; and a proportion of the weight of each of the raw materials to a total weight of the commodity.

The learning unit 81 may generate the prediction model with which a prediction formula is determined depending on a value of a variable used in demand prediction of the target commodity. The prediction unit 82 may specify, from the generated prediction model, the prediction formula depending on the value of the variable used in the demand prediction of the target commodity, and predict the demand quantity of the target commodity using the specified prediction formula.

Although the present invention has been described with reference to the exemplary embodiments and examples, the present invention is not limited to the foregoing exemplary embodiments and examples. Various changes understandable by those skilled in the art can be made to the structures and details of the present invention within the scope of the present invention.

This application claims priority based on Japanese Patent Application No. 2016-212923 filed on Oct. 31, 2016, the disclosure of which is incorporated herein in its entirety.

### REFERENCE SIGNS LIST

10 storage unit
20 learning unit
30 prediction unit
40 output unit
100 commodity demand prediction system

What is claimed is:

1. A commodity demand prediction system comprising:
a hardware including a processor;
a learning unit, implemented by the processor, which learns a prediction model, based on learning data including information about a raw material of a commodity and a demand quantity of the commodity; and
a prediction unit, implemented by the processor, which predicts a demand quantity of a target commodity,
wherein the prediction unit predicts the demand quantity of the target commodity in a prediction target period, based on the prediction model and a raw material of the target commodity.

2. The commodity demand prediction system according to claim 1, wherein the learning unit learns the prediction model, based on the learning data including the raw material used in the commodity and the demand quantity of the commodity.

3. The commodity demand prediction system according to claim 1, wherein the learning unit learns the prediction model, based on the learning data including at least one of: a total weight of one or more raw materials of the commodity; a weight of each of the raw materials; and a proportion of the weight of each of the raw materials to a total weight of the commodity.

4. The commodity demand prediction system according to claim 1, wherein the learning unit generates one prediction model including a demand quantity as an objective variable and a variable representing information about a raw material of a commodity as an explanatory variable.

5. The commodity demand prediction system according to claim 1, wherein the learning unit generates the prediction model with which a prediction formula is determined depending on a value of a variable used in demand prediction of the target commodity, and
wherein the prediction unit specifies, from the generated prediction model, the prediction formula depending on the value of the variable used in the demand prediction of the target commodity, and predicts the demand quantity of the target commodity using the specified prediction formula.

6. A commodity demand prediction method comprising:
learning a prediction model, based on learning data including information about a raw material of a commodity and a demand quantity of the commodity; and
predicting a demand quantity of a target commodity in a prediction target period, based on the prediction model and a raw material of the target commodity.

7. The commodity demand prediction method according to claim 6, wherein the prediction model is learned based on the learning data including the raw material used in the commodity and the demand quantity of the commodity.

8. A non-transitory computer readable information recording medium storing a commodity demand prediction program, when executed by a processor, that performs a method for:
learning a prediction model, based on learning data including information about a raw material of a commodity and a demand quantity of the commodity; and
predicting a demand quantity of a target commodity in a prediction target period, based on the prediction model and a raw material of the target commodity.

9. The non-transitory computer readable information recording medium according to claim 8, wherein the prediction model is learned based on the learning data including the raw material used in the commodity and the demand quantity of the commodity.
